(19) United States
(12) Patent Application Publication
(10) Pub. No.: US 2025/0103921 A1
(43) Pub. Date: Mar. 27, 2025

(54) SYSTEMS AND METHODS TO PROCESS A PLURALITY OF INFORMATION SIMULTANEOUSLY TO GENERATE OUTPUTS

(71) Applicant: Disney Enterprises, Inc., Burbank, CA (US)

(72) Inventors: Daniel Richner, Burbank, CA (US); David L. Crush, Burbank, CA (US); Michael Allen Bodkin, Burbank, CA (US)

(21) Appl. No.: 18/607,110

(22) Filed: Mar. 15, 2024

Related U.S. Application Data
(60) Provisional application No. 63/584,371, filed on Sep. 21, 2023.

(51) Int. Cl. G06N 5/025

(52) U.S. Cl. CPC G06N 5/025

(57) ABSTRACT

Systems and methods to process a plurality of information simultaneously to generate outputs are disclosed. Exemplary implementations may: execute individual instances of an executable program for individual information sources such that a first engine instance of a rules engine is executed for a first information source; establish communication between electronic storage and the first engine instance via a transceiver that enables communication between the electronic storage, information sources, one or more processors, and/or external resources such that import of the atomic rules, the business rules, and/or one or more specialized rules to the first engine instance is enabled; and establish communication between the first information source and the first engine instance via the transceiver so that individual information objects from the first information source are received by the first engine instance in an ongoing manner.

### CROSS-REFERENCE TO RELATED APPLICATIONS

The present application claims priority benefit of the U.S. Provisional Patent Application No. 63/584,371 titled “Context Driven Emergent Rules Engine” filed on Sep. 21, 2023, the contents of which are incorporated herein by reference in their entirety. The subject matter of this related application is hereby incorporated herein by reference.

### FIELD OF THE DISCLOSURE

The present disclosure relates to systems and methods to process a plurality of information simultaneously to generate outputs.

### BACKGROUND

Existing systems that employ rules engines may require that all rules and conditions are loaded into memory before the rules engine generate an output. Additionally, the existing systems may collect a plurality of information into the memory in batches to establish context before processing the information. This approach may slow processing time and increases the memory use.

### SUMMARY

One aspect of the present disclosure related to pieces of information processed by the claimed system not being processed in “batches” by a rules engine but rather processed individually and efficiently as the pieces of information are obtained in an ongoing manner. That is, atomic rules and business rules are employed on the individual pieces of information to trigger obtainment of additional rules that should be applied to the pieces of information, and/or trigger obtainment of addition information that may either be final results or facilitate further obtainment of additional rules. Thus, processing the pieces of information is driven by the information itself to avoid inefficient overuse of memory and increase processing speed.

The system may include electronic storage, a transceiver, one or more hardware processors configured by machine-readable instructions, and/or other system components. The machine-readable instructions may include one or more instruction components. The instruction components may include computer program components. The instruction components may include one or more of instance execution component, communication establishing component, and/or other instruction components.

The electronic storage may store at least an executable program, atomic rules, business rules, and/or other information. The executable program may effectuate individual instances of a rules engine upon execution. Individual ones of the atomic rules may facilitate with classification of information. Individual ones of the business rules may be associated with a function and one or more conditions that effectuate the function upon satisfaction of the one or more conditions.

The transceiver may enable communication between the electronic storage, information sources, the one or more processors, external resources, and/or other components.

The instance execution component may be configured to execute individual instances of the executable program for individual ones of the information sources. By way of non-limiting example, a first engine instance of the rules engine may be executed for a first information source. The information sources may include the first information source and/or other information sources.

The communication establishing component may be configured to establish communication between the electronic storage and the first engine instance via the transceiver to enable import of the atomic rules, the business rules, one or more specialized rules to the first engine instance, and/or other rules or information. The communication establishing component may be configured to establish communication between the first information source and the first engine instance via the transceiver so that individual information objects from the first information source are received by the first engine instance in an ongoing manner. The individual information objects may convey attributes of individual subjects. The first engine instance may be configured to (a) generate knowledge capsules based on the individual information objects by determining parameters and corresponding parameter values for the attributes conveyed by the individual information objects. The knowledge capsules may include at least the parameters and the corresponding parameter values for the attributes. Next (b), the first engine instance may be configured to import the atomic rules, the business rules, and/or one or more of the specialized rules from the electronic storage. Next (c), the first engine instance may be configured to simultaneously employ the atomic rules and the one or more specialized rules applicable to the parameter values corresponding to the attributes so that classifications of the individual knowledge capsules are determined and stored to the individual knowledge capsules. The individual atomic rules and the one or more specialized rules may apply to distinct ones of the attributes and its corresponding parameter values.

Next (d), the first engine instance may be configured to determine whether the classifications of the individual knowledge capsules satisfy the one or more conditions of the individual business rules. Next (e), the first engine instance may be configured to upon the classifications of the individual knowledge capsules failing to satisfy the one or more conditions of the one or more business rules, output the individual knowledge capsules to one of the external resources.

Next (f), the first engine instance may be configured to upon the classifications of the individual knowledge capsules satisfying the one or more conditions of one or more of the business rules, employ the one or more business rules for the individual knowledge capsules. Employment of individual ones of the one or more business rules in the set may cause: (i) obtainment of additional information objects relevant to the individual knowledge capsules from the external resources and/or the first information source, and storage of the additional information objects in the individual knowledge capsules and return to step (c), or (ii) return to step (b) to initiate obtainment of a set of the specialized rules.

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured to process a plurality of information simultaneously to generate outputs, in accordance with one or more implementations.

FIG. 2 illustrates a method to process a plurality of information simultaneously to generate outputs, in accordance with one or more implementations.

FIG. 3 illustrates an example implementation of the system configured to process a plurality of information simultaneously to generate outputs, in accordance with one or more implementations.

### DETAILED DESCRIPTION

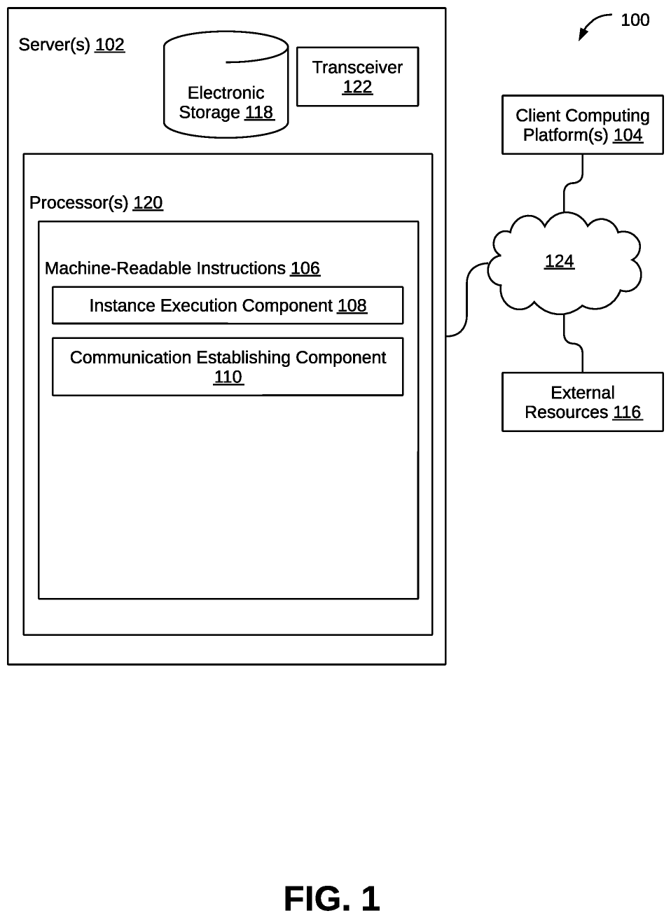

FIG. 1 illustrates a system 100 configured to process a plurality of information simultaneously to generate outputs, in accordance with one or more implementations. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Server(s) 102 may include electronic storage 118, transceiver 122, and/or other components. Electronic storage 118 may store an executable program, atomic rules, business rules, and/or other information. The executable program may effectuate individual instances of a rules engine upon execution. The rules engine may refer to functions effectuated based on information received from information sources, described herein, that may cause changes to systems external to system 100 that is communicable via a network 124, changes to the information sources, cause presentation of information via client computing platform(s) 104, transmit information to the systems external to system 100, transmit information to the information sources, and/or other consequences.

Individual ones of the atomic rules may facilitate with classification of information. Classification of the information may apply to attributes represented by knowledge capsules described herein. The individual atomic rules may be a two option inquiry that facilitate classifying the individual attributes. By way of non-limiting example, the two options that answer an inquiry may be yes or no, true or false, 0 or 1, and/or other two options.

Individual ones of the business rules may be associated with a function, one or more conditions, and/or other information. The one or more conditions may effectuate the function upon satisfaction of the one or more conditions. In some implementations where business rules are associated with more than one condition, all of the conditions must be satisfied to effectuate the associated function. The function associated with the individual business rules may include causing obtainment or import of a specialized set of rules, causing obtainment or import of additional information from external resources 116, causing obtainment or import of additional information from information sources described herein, request external services (e.g., maintenance services, emergency services), causing external devices to operate in a particular manner (e.g., display a particular message on a digital sign), generate instructions for large language model and/or other artificial intelligence models, and/or other functions.

Transceiver 122 may enable communication between electronic storage 118, the information sources, one or more processor(s) 106 (and components thereof), external resources 116, and/or other elements via network 124. Transceiver 122 may initiate, facilitate, and maintain the communication until terminated. By way of non-limiting example, transceiver 122 may include one or more of a radiofrequency (RF) transceiver, a fiber-optic transceiver, an Ethernet transceiver, a wireless transceiver, and/or other devices that enable communication of information to and from multiple elements of system 100. Termination of the communication may include powering off transceiver 122, disconnecting transceiver 122, and/or other methods of terminating the communication.

Machine-readable instructions 106 may include one or more instruction components. The instruction components may include computer program components. The instruction components may include one or more of instance execution component 108, communication establishing component 110, and/or other instruction components.

Instance execution component 108 may be configured to execute individual instances of the executable program for individual information sources. An instance of the executable program may be a copy of the executable program so that a replica of the rules engine is running for the individual information sources. In some implementations, the instances may be running on virtual server(s). In some implementations, the instances may be running on physical server(s) such as server(s) 102 or other server(s) external to system 100 that are communicable via network 124 and/or transceiver 122. The individual information sources may be for subjects that generate information during execution, training, idle, and/or other operation statuses. By way of non-limiting example, the subjects may include one or more of a ride attraction, one or more vehicles of the ride attraction, multi-passenger vehicles, single-passenger vehicles, image capture devices, computing devices, among other subjects. The information sources may include one or more servers, one or more databases, one or more cloud storage, and/or other information sources that are collect and/or store the information for the associated subjects. By way of non-limiting example, the information sources may include a first information source and/or other information sources. As such, a first engine instance of the rules engine may be executed for the first information source.

It is to be understood that description of the first engine instance and the first information source is one example of executing the executable program and is not intended to be limiting as a second engine instance of the rules engine may be executed for a second information source, and a third engine instance of the rules engine may be executed for a third information source, and so on, simultaneously as permitted by memory of one or more processor(s) 106, client computing platform(s) 104, and/or other elements of system 100.

Communication establishing component 110 may be configured to establish communication between electronic storage 118 and the first engine instance via transceiver 122 and/or network 124. The established communication may enable import of the atomic rules, the business rules, one or more specialized rules, and/or other information from electronic storage 118 and/or other storage to the first engine instance. In some implementations, electronic storage 118 and/or other electronic storage may store the one or more specialized rules. The specialized rules may include other atomic rules, other business rules, or both. The other atomic rules and the other business rules may be rules that are nonessential until prompted. Thus, such specialized rules may not be obtained or imported until other ones of the business rules causes the obtainment. The specialized rules may be applied in the same manner as the atomic rules and the business rules described herein subsequent to obtainment.

Communication establishing component 110 may be configured to establish communication between the first information source and the first engine instance via transceiver 122 and/or network 124. Thus, individual information objects from the first information source may be received by the first engine instance in an ongoing manner. Receiving the information objects from the first information source may refer to transferring the information objects from the first information source to the first engine instance, requesting the first information source to generate a copy of the information objects and subsequently transfer the copy from the first information source to the first engine instance, moving the information objects from the first information source to the first engine instance, and/or other techniques of obtaining the information objects. The term “ongoing manner” as used herein may refer to continuing to perform an action (e.g., receive) periodically (e.g., every 30 seconds, every minute, every hour, etc.) until receipt of an indication to terminate. The indication to terminate may include terminating run of the instances of the rules engine, pausing run of the instances, terminating the communication between the instances and other elements, and/or other indications of termination.

The individual information objects may convey the attributes of the individual subjects. An individual information object for a subject may define an entity included in the subject. Thus, the attributes conveyed by the information object may define the entity that comprises part of the subject. By way of non-limiting example, the subject may be a ride attraction vehicle of a ride attraction. The ride attraction may include multiple entities including four wheels, a brake system, a battery, and/or other entities. In some implementations, the subjects that a given information source, e.g., the first information source, provides the information objects for may be different. For example, the ride attraction may include multiple ride attraction vehicles, a sound system, a lighting system, and/or other subjects. These individual subjects may include multiple entities that are defined by the multiple information objects, and thus define the individual subjects.

The attributes of the individual information objects may be formatted in manner that is particular for the information source, the subject itself, and/or the entity itself, and thus may vary. By way of non-limiting example, the attributes for a first wheel of the ride attraction vehicle may include tire life, tire compound, average revolutions per minute per ride iteration, and/or other attributes. A unique identifier may be associated with the individual information objects. In some implementations, the unique identifiers are associated with the individual information objects within the information sources originated in. In some implementations, where the individual information objects are not associated with individual unique identifiers, the first engine instance may be configured to assign unique identifiers to the individual information objects.

Responsive to establishment of the communication between and electronic storage 118 and the first engine instance, and between the first information source and the first engine instance, the first engine instance may be configured to (a) generate individual knowledge capsules based on the individual information objects by determining parameters and corresponding parameter values for the attributes conveyed by the individual information objects. That is, generating the knowledge capsules for the information objects includes generalizing the attributes conveyed in the information objects to simplified format such as a parameter-and-parameter value format. By way of non-limiting example, the simplified format may include strings, numbers, boolean, and/or other formats. In some implementations, determining the parameters and the corresponding parameter values for the attributes conveyed by the individual information objects may include employing domain modeling, semantic modeling, and/or other techniques for generalizing the attributes to establish the knowledge capsules. Thus, the knowledge capsules may include at least the parameters and the corresponding parameter values for the attributes of the entities that comprise the individual subjects. In some implementations, determining the parameters may be based on a set of common parameters that the first engine instance is configured to identify. In some implementations, the set of common parameters may be predefined in the executable program so that the individual instances of the rules engine may be configured to identify the set of common parameters and corresponding parameter values first, if relevant, and determine other parameters and corresponding values. In some implementations, the knowledge capsules may be associated with unique identifiers. The unique identifiers associated with the knowledge capsules may be assigned at generation of the knowledge capsules.

The first engine instance may be configured to (b) import the atomic rules, the business rules, one or more of the specialized rules, and/or other information from electronic storage 118 and/or other electronic storage. In some implementations, all the atomic rules may be imported. In some implementations, a subset of the business rules that may be directly triggered by results of the atomic rules may be imported. In some implementations, all the business rules may be imported. Further, the one or more specialized rules may be imported in response to employing one of the business rules and/or the atomic rules. The term “import”, and variations thereof as used herein, may refer to creating and temporarily storing a copy of the atomic rules, the business rules, one or more of the specialized rules, and/or other information in a memory associated with the first engine instance so that such may be employed or otherwise utilized at a later time. Thus, the atomic rules, the business rules, one or more of the specialized rules, and/or other information may still be stored in electronic storage 118 and/or other electronic storage, and the first engine instance additionally.

The first engine instance may be configured to (c) simultaneously employ the atomic rules to the parameter values for the parameters that correspond to the attributes. In some implementations, the first engine instance may further simultaneously employ the one or more specialized rules when applicable. Employing the atomic rules may determine classifications of the individual knowledge capsules based on the parameter values and store such classifications to the individual knowledge capsules. In some implementations, the individual atomic rules and the individual one or more specialized rules may apply to distinct or particular ones of the attributes and its corresponding parameter values. In some implementations, the individual parameters may be associated with multiple classifications that the corresponding parameter values may be individually classified in. The classifications may include, but are not limited to, a particular operation mode (e.g., on, off, up, down), fault presence, a type of fault, a particular operation status (e.g., open, closed), operating temperature range, a particular operating temperature range status (e.g., safe, unsafe, nearing unsafe), a particular maintenance status (e.g., required, recommended, up-to-date), a particular location (e.g., state, city, neighborhood, fictional land, park), and/or other classifications.

The first engine instance may be configured to (d) determine whether the classifications of the individual knowledge capsules satisfy the one or more conditions of the individual business rules already imported by the first engine instance. In some implementations, determining whether a condition is satisfied or not may include determining whether a given parameter value for a given parameter (that represents a given attribute) is part of a particular classification. In some implementations, determining whether the condition is satisfied or not may include determining whether the given parameter value for the given parameter is part of multiple classifications.

The first engine instance may be configured to (e) upon the classifications of the individual knowledge capsules failing to satisfy the one or more conditions of the one or more business rules, output the individual knowledge capsules to one of the external resources 116, other server(s), and/or other electronic locations. Outputting the individual knowledge capsules may include causing presentation of the individual knowledge capsules on a display device of client computing platform(s) 104 associated with users, transmitting the individual knowledge capsules to the other server(s) for utilization, transmitting the individual knowledge capsules to the other server(s) for presentation, storing the knowledge capsules in electronic storage 118 and/or other electronic storage, and/or other outputs.

The first engine instance may be configured to (f) upon the classifications of the individual knowledge capsules satisfying the one or more conditions of one or more of the business rules, employ the one or more business rules for the individual knowledge capsules. That is, by way of non-limiting example, upon the one or more conditions associated with a first business rule being satisfied by the classifications, the first business rule may be employed for a first knowledge capsule. In some implementations, more than one business rule may be employed at once upon determination that the corresponding one or more conditions are satisfied.

The employment of individual ones of the one or more business rules in the set may cause (i) obtainment of additional ones of the information objects relevant to the individual knowledge capsules from external resources 116, electronic storage 118, other electronic storage, the first information source, and/or other sources. The obtained additional information objects may be stored in the individual knowledge capsules that employed the one or more business rules which caused the obtainment. Subsequently, the first engine instance may return to step (a) so that additional parameter values for additional parameters are determined for additional attributes conveyed by the additional information objects. In some implementations, the first engine instance may determine whether a given information object is obtained in response to employment of one or more of the business rules imported. In some implementations, upon the first engine instance obtaining the given information object (such as the additional information objects) in response to the one or more of the business rules, the additional parameter values for additional parameters determined for the additional attributes conveyed by the additional information objects may be stored to the knowledge capsules that caused the obtainment.

Subsequently, the first engine instance may continue to the subsequent steps such as step (c) so that the atomic rules, and/or the one or more specialized rules, if applicable, may be applied to the parameter values corresponding to the attributes such that additional classifications of the parameter values may be determined and stored in corresponding the knowledge capsules, electronic storage 118, and/or other electronic storage.

In some implementations, the employment of individual ones of the one or more business rules in the set may cause return to step (b) to initiate obtainment of a set of the specialized rules. Furthermore, steps subsequent to step (b) may be executed.

In some implementations, the first engine instance may be configured to determine whether a memory of one or more processor(s) 106 is capable of supporting the obtainment initiated by sub-step (i) or (ii). In some implementations, the obtainment initiated by sub-step (i) or (ii) may be associated with a particular amount of memory required. Thus, the first engine instance may be configured to determine whether the memory of one or more processor(s) 106 has the particular amount of memory available. Sub-step (i) or (ii) may be executed upon determination that the memory is capable of supporting the obtainment.

Upon determination that the memory is not capable of supporting the obtainment, the first engine instance may be configured to output both the given knowledge capsule that a given business rule is be employed for and the given business rule being employed in association with the given knowledge capsule. The knowledge capsules may include the given knowledge capsule and/or other knowledge capsules. The output of the given knowledge capsule and the given business rule may initiate an additional engine instance execution by executing the executable program. As such, a second engine instance of the rules engine is executed. Thus, the second engine instance may be configured to execute steps (b)-(f) for the given knowledge capsule and the given business rule output by the first engine instance, and subsequently obtained information objects, and/or other ones of the specialized rules.

In some implementations, the first engine instance may employ a monitor system in an ongoing manner. The monitor system may monitor employment of the imported atomic rules, the business rules, and the specialized rules. Monitoring the employment of such rules may determine how often individual ones of the rules are employed, a time and date of last employment of the individual rules, how many times the individual rules have been employed, which responses to rules cause employment of other ones of the rules, and/or other employment information regarding to the rules. The monitoring system may further log traces, debugging information for bugs, timing information for the traces and the bugs, and/or other information. The traces may capture execution of functions/code such that historical executions may be accessible by users. The debugging information may include one or more events that caused bugs in the executions and/or employments of rules, one or more parameter values included in the one or more events, and/or other information. An event may include employing one or more of the atomic rules, the business rules, the specialized rules; importing one or more of the atomic rules, the business rules, the specialized rules, establishing the communications between the instances, electronic storage 118, other electronic storage, the individual information sources, generating the knowledge capsules, determining satisfaction of the one or more conditions, the obtainment of the additional information objects, the obtainment of the set of the specialized rules, the output, and/or other events. The timing information may include a date, a time, an engine instance, the unique identifier, and/or other timing information. The traces, the debugging information for the bugs, the timing information for the traces and the bugs, and/or other information may be stored in electronic storage 118 stored in other electronic storage, and/or exported to other server(s) so that it is accessible by the users via client computing platform(s) 104 for analysis. In some implementations, based on the traces, the debugging information for the bugs, the timing information for the traces and the bugs, and/or other information the monitoring system may indicate lack of employment of particular ones of the rules and thus unload the particular rules from the first engine instance.

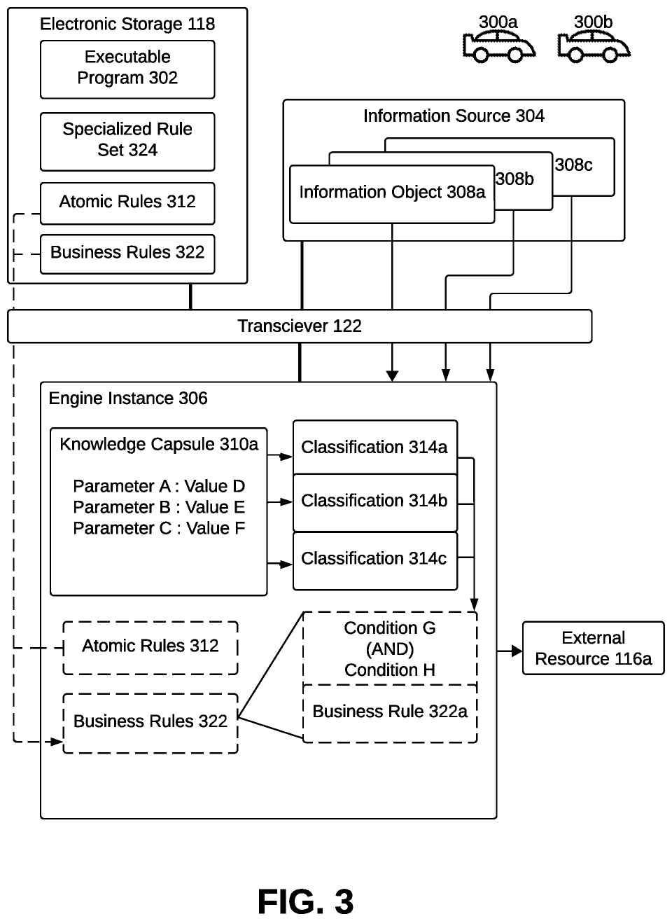

FIG. 3 illustrates electronic storage 118 (the same as in FIG. 1), an information source 304, and transceiver 122 (the same as in FIG. 1). Electronic storage 118 may store executable program 302, specialized rule set 324, atomic rules 312, and business rules 322. Responsive to executing executable program 302, engine instances of a rules engine may be initiated for multiple information sources such that engine instance 306 for information source 304 is initiated. Information source 304 may include information objects 308a-c that convey attributes about individual subjects such as vehicle 300a and vehicle 300b. Information object 308a and 308b may convey attributes about vehicle 300a, and information object 308c may convey attributes about vehicle 300b. Information object 308a may be convey attributes about a front left tire for vehicle 300a, for example. By way of transceiver 122, information objects 308a-c may be received by engine instance 306 from information source 304. Engine instance 306 may cause a knowledge capsule 310a to be generated for information object 308a so that the attributes conveyed by information object 308a are represented as parameters A, B, C with corresponding values D, E, F, respectively. Engine instance 306 may cause atomic rules 312 and business rules 322 to import into engine instance 306 from electronic storage 118. Upon employing atomic rules 312 to knowledge capsule 310a, classifications 314a-c may be simultaneously determined. Engine instance 306 may determine whether conditions associated with individual ones of the business rules 322 are satisfied by classifications 314a-c. That is, engine instance 306 may determine whether condition G and condition H associated with business rules 322a are satisfied by classifications 314a-c. Upon determination of satisfaction, business rules 322a may be employed. Business rule 322a may cause obtainment and import of specialized rule set 324 from electronic storage 118. Upon determination of failure of satisfaction, knowledge capsule 310a may be exported to external resource 116a (i.e., one of the external resources in FIG. 1).

Referring back to FIG. 1 in some implementations, server(s) 102, client computing platform(s) 104, and/or external resources 116 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 116 may be operatively linked via some other communication media.

A given client computing platform 104 may include one or more processors configured to execute computer program components. The computer program components may be configured to enable an expert or user associated with the given client computing platform 104 to interface with system 100 and/or external resources 116, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 116 may include sources of information outside of system 100, external entities participating with system 100, and/or other resources. In some implementations, some or all of the functionality attributed herein to external resources 116 may be provided by resources included in system 100.

Server(s) 102 may include electronic storage 118, one or more processors 120, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 118 may comprise non-transitory storage media that electronically stores information. The electronic storage media of electronic storage 118 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 118 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 118 may include one or more virtual storage resources (e.g., cloud storage, a virtual private network, and/or other virtual storage resources), may be distributed and operate independently from server(s) 102. Electronic storage 118 may store software algorithms, information determined by processor(s) 120, information received from server(s) 102, information received from client computing platform(s) 104, and/or other information that enables server(s) 102 to function as described herein.

Processor(s) 120 may be configured to provide information processing capabilities in server(s) 102. As such, processor(s) 120 may include one or more of a digital processor, an analog processor, a digital circuit designed to process information, an analog circuit designed to process information, a state machine, and/or other mechanisms for electronically processing information. Although processor(s) 120 is shown in FIG. 1 as a single entity, this is for illustrative purposes only. In some implementations, processor(s) 120 may include a plurality of processing units. These processing units may be physically located within the same device, or processor(s) 120 may represent processing functionality of a plurality of devices operating in coordination. Processor(s) 120 may be configured to execute components 108 and/or 110, and/or other components. Processor(s) 120 may be configured to execute components 108 and/or 110, and/or other components by software; hardware; firmware; some combination of software, hardware, and/or firmware; and/or other mechanisms for configuring processing capabilities on processor(s) 120. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108 and/or 110 are illustrated in FIG. 1 as being implemented within a single processing unit, in implementations in which processor(s) 120 includes multiple processing units, one or more of components 108 and/or 110 may be implemented remotely from the other components. The description of the functionality provided by the different components 108 and/or 110 described below is for illustrative purposes, and is not intended to be limiting, as any of components 108 and/or 110 may provide more or less functionality than is described. For example, one or more of components 108 and/or 110 may be eliminated, and some or all of its functionality may be provided by other ones of components 108 and/or 110. As another example, processor(s) 120 may be configured to execute one or more additional components that may perform some or all of the functionality attributed below to one of components 108 and/or 110.

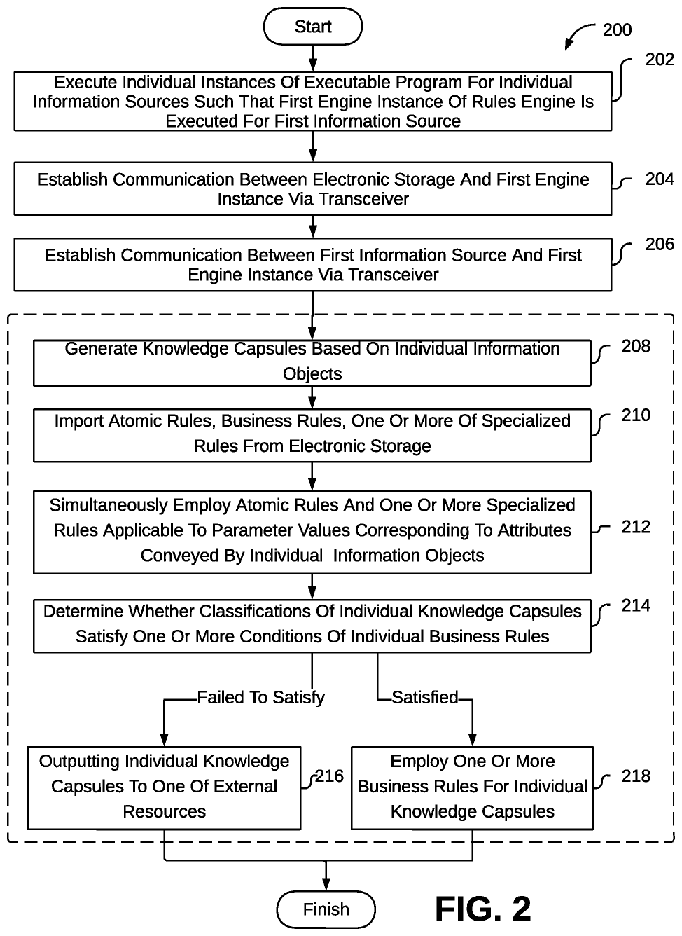

FIG. 2 illustrates a method 200 to process a plurality of information simultaneously to generate outputs, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include executing individual instances of an executable program for individual information sources such that a first engine instance of a rules engine is executed for a first information source. The information sources may include the first information source. Operation 202 may be performed by one or more hardware processors configured by machine-readable instructions including a component that is the same as or similar to instance execution component 108, in accordance with one or more implementations.

An operation 204 may include establishing communication between an electronic storage and the first engine instance via a transceiver that enables communication between the electronic storage, information sources, one or more processors, and/or external resources such that import of the atomic rules, the business rules, and/or one or more specialized rules to the first engine instance is enabled. Operation 204 may be performed by one or more hardware processors configured by machine-readable instructions including a component that is the same as or similar to communication establishing component 110, in accordance with one or more implementations.

An operation 206 may include establishing communication between the first information source and the first engine instance via the transceiver so that individual information objects from the first information source are received by the first engine instance in an ongoing manner. Operation 206 may be performed by one or more hardware processors configured by machine-readable instructions including a component that is the same as or similar to communication establishing component 110, in accordance with one or more implementations.

A sub-operation 208 may include generating knowledge capsules based on the individual information objects by determining parameters and corresponding parameter values for the attributes conveyed by the individual information objects. The knowledge capsules may include at least the parameters and the corresponding parameter values for the attributes.

A sub-operation 210 may include importing the atomic rules, the business rules, one or more of the specialized rules, and/or other information from electronic storage 118 illustrated in FIG. 1.

A sub-operation 212 may include simultaneously employing the atomic rules and the one or more specialized rules applicable to the parameter values corresponding to the attributes so that classifications of the individual knowledge capsules are determined and stored to the individual knowledge capsules.

A sub-operation 214 may include determining whether the classifications of the individual knowledge capsules satisfy the one or more conditions of the individual business rules.

A sub-operation 216 may include, upon the classifications of the individual knowledge capsules failing to satisfy the one or more conditions of the one or more business rules, outputting the individual knowledge capsules to one of the external resources.

A sub-operation 218 may include, upon the classifications of the individual knowledge capsules satisfying the one or more conditions of one or more of the business rules, employing the one or more business rules for the individual knowledge capsules.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured to process a plurality of information simultaneously to generate outputs, the system comprising:
electronic storage that stores at least an executable program, atomic rules, and business rules, wherein the executable program effectuates individual instances of a rules engine upon execution, wherein individual ones of the atomic rules facilitate with classification of information, wherein individual ones of the business rules are associated with a function and one or more conditions that effectuate the function upon satisfaction of the one or more conditions;
transceiver that enables communication between the electronic storage, information sources, one or more processors, and/or external resources; and
the one or more processors configured by machine-readable instructions:
execute individual instances of the executable program for individual ones of the information sources such that a first engine instance of the rules engine is executed for a first information source, wherein the information sources include the first information source;
establish communication between the electronic storage and the first engine instance via the transceiver to enable import of the atomic rules, the business rules, and/or one or more specialized rules to the first engine instance;
establish communication between the first information source and the first engine instance via the transceiver so that individual information objects from the first information source are received by the first engine instance in an ongoing manner, wherein the individual information objects convey attributes of individual subjects, wherein the first engine instance is configured to:
(a) generate knowledge capsules based on the individual information objects by determining parameters and corresponding parameter values for the attributes conveyed by the individual information objects, wherein the knowledge capsules include at least the parameters and the corresponding parameter values for the attributes;
(b) import the atomic rules, the business rules, and/or one or more of the specialized rules from the electronic storage;
(c) simultaneously employ the atomic rules and the one or more specialized rules applicable to the parameter values corresponding to the attributes so that classifications of the individual knowledge capsules are determined and stored to the individual knowledge capsules, wherein the individual atomic rules and the one or more specialized rules apply to distinct ones of the attributes and its corresponding parameter values;
(d) determine whether the classifications of the individual knowledge capsules satisfy the one or more conditions of the individual business rules;
(e) upon the classifications of the individual knowledge capsules failing to satisfy the one or more conditions of the one or more business rules, output the individual knowledge capsules to one of the external resources;
(f) upon the classifications of the individual knowledge capsules satisfying the one or more conditions of one or more of the business rules, employ the one or more business rules for the individual knowledge capsules, wherein employment of individual ones of the one or more business rules in the set causes:
(i) obtainment of additional information objects relevant to the individual knowledge capsules from the external resources and/or the first information source, and storage of the additional information objects in the individual knowledge capsules and return to step (a), or
(ii) return to step (b) to initiate obtainment of a set of the specialized rules.

2. The system of claim 1, wherein a unique identifier is associated with the individual information objects and the corresponding knowledge capsules.

3. The system of claim 1, wherein step (f) includes:
determining whether a memory of the one or more processors is capable of supporting the obtainment initiated by sub-step (i) or (ii), wherein sub-step (i) or (ii) is executed upon determination that the memory is capable of supporting the obtainment; and
upon determination that the memory is not capable of supporting the obtainment, output a given knowledge capsule that a given business rule is being employed for and output the given business rule being employed in associated with the given knowledge capsule, wherein the output of the given knowledge capsule and the given business rule initiates additional engine instance execution such that a second engine instance of the rules engine is executed and steps (b)-(f) are executable for the given knowledge capsule and the given business rule, wherein the knowledge capsules include the given knowledge capsule.

4. The system of claim 1, wherein the first engine instances may be configured to employ a monitoring system that monitors employment of the atomic rules, the business rules, and the specialized rules.

5. The system of claim 1, wherein the first engine instances may be configured to unload particular ones of the atomic rules, the business rules, and the specialized rules responsive to determination that the particular atomic rules, the particular business rules, and the particular specialized rules are unemployed as indicated by the monitoring system.

6. A method to process a plurality of information simultaneously to generate outputs, the method comprising:
executing individual instances of an executable program for individual information sources such that a first engine instance of a rules engine is executed for a first information source, wherein the information sources include the first information source, wherein electronic storage stores the executable program, atomic rules, and business rules, wherein the executable program effectuates individual instances of the rules engine upon execution, wherein individual ones of the atomic rules facilitate with classification of information, wherein individual ones of the business rules are associated with a function and one or more conditions that effectuate the function upon satisfaction of the one or more conditions;
establishing communication between the electronic storage and the first engine instance via a transceiver that enables communication between the electronic storage, information sources, one or more processors, and/or external resources such that import of the atomic rules, the business rules, and/or one or more specialized rules to the first engine instance is enabled;
establishing communication between the first information source and the first engine instance via the transceiver so that individual information objects from the first information source are received by the first engine instance in an ongoing manner, wherein the individual information objects convey attributes of individual subjects, wherein the first engine instance is configured to:
(a) generate knowledge capsules based on the individual information objects by determining parameters and corresponding parameter values for the attributes conveyed by the individual information objects, wherein the knowledge capsules include at least the parameters and the corresponding parameter values for the attributes;
(b) import the atomic rules, the business rules, and/or one or more of the specialized rules from the electronic storage;
(c) simultaneously employ the atomic rules and the one or more specialized rules applicable to the parameter values corresponding to the attributes so that classifications of the individual knowledge capsules are determined and stored to the individual knowledge capsules, wherein the individual atomic rules and the one or more specialized rules apply to distinct ones of the attributes and its corresponding parameter values;
(d) determine whether the classifications of the individual knowledge capsules satisfy the one or more conditions of the individual business rules;
(e) upon the classifications of the individual knowledge capsules failing to satisfy the one or more conditions of the one or more business rules, output the individual knowledge capsules to one of the external resources;
(f) upon the classifications of the individual knowledge capsules satisfying the one or more conditions of one or more of the business rules, employ the one or more business rules for the individual knowledge capsules, wherein employment of individual ones of the one or more business rules in the set causes:
(i) obtainment of additional information objects relevant to the individual knowledge capsules from the external resources and/or the first information source, and storage of the additional information objects in the individual knowledge capsules and return to step (a), or
(ii) return to step (b) to initiate obtainment of a set of the specialized rules.

7. The method of claim 6, wherein a unique identifier is associated with the individual information objects and the corresponding knowledge capsules.

8. The method of claim 6, wherein step (f) includes:
determining whether a memory of the one or more processors is capable of supporting the obtainment initiated by sub-step (i) or (ii), wherein sub-step (i) or (ii) is executed upon determination that the memory is capable of supporting the obtainment; and
upon determination that the memory is not capable of supporting the obtainment, output a given knowledge capsule that a given business rule is being employed for and output the given business rule being employed in associated with the given knowledge capsule, wherein the output of the given knowledge capsule and the given business rule initiates additional engine instance execution such that a second engine instance of the rules engine is executed and steps (b)-(f) are executable for the given knowledge capsule and the given business rule, wherein the knowledge capsules include the given knowledge capsule.

9. The method of claim 6, wherein the first engine instances may be configured to employ a monitoring system that monitors employment of the atomic rules, the business rules, and the specialized rules.

10. The method of claim 6, wherein the first engine instances may be configured to unload particular ones of the atomic rules, the business rules, and the specialized rules responsive to determination that the particular atomic rules, the particular business rules, and the particular specialized rules are unemployed as indicated by the monitoring system.
